(19) United States
(12) Patent Application Publication
(10) Pub. No.: US 2003/0119576 A1
(43) Pub. Date: Jun. 26, 2003

(54) Gaming devices and methods incorporating interactive physical skill bonus games and virtual reality games in a shared bonus event

(76) Inventors: Monica A. McClintic, Boulder City, NV (US); Alan D. Williams, Las Vegas, NV (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/029,225

(22) Filed: Dec. 20, 2001

(51) Int. Cl. A63F 13/00

(52) U.S. Cl. 463/20; 463/25

(57) ABSTRACT

Gaming devices and methods useful with a gaming system offering a shared bonus event, which may be a Virtual Reality event. One embodiment features a number of gaming machines networked to a bonus event computer. Each gaming machine includes a primary game that results in various outcomes in response to placement of a wager. Achieving a specific outcome provides a player with an opportunity to play a skill-based bonus game on that machine, such as a carnival-like game that awards a bonus based on performing a physical act. The skill-based bonus game may be a Virtual Reality game. The bonus computer provides a shared Virtual Reality bonus event to qualified players, allowing the players to compete for additional bonus event prizes. Aspects of the shared Virtual Reality bonus event may be randomly assigned and the event may be a Virtual Reality auto race.

### BACKGROUND OF THE INVENTION

1. Field of the Invention

The present invention is directed to methods and apparatus of playing wagering games. More specifically, the present invention is directed to methods and gaming devices that include a first gaming unit for conducting a game of chance and a second gaming unit for conducting shared Virtual Reality bonus events or interactive skill based bonus games to allow bonus game awards to be valued in relation to a player's physical skill and corresponding performance in the bonus game.

2. State of the Art

Games of chance have been enjoyed by people for thousands of years and have enjoyed widespread popularity in recent times. Many people enjoy playing variations of games that they have not previously played before. Playing new variations of games adds to the excitement of this recreational activity particularly when some form of wagering is involved. As used herein, the terms “game” and “gaming” are used to indicate that some form of wagering is involved and that players must make wagers of value, whether actual currency or some equivalent of value, e.g., token or credit.

Game machines have long been a significant facet of the gaming industry. A basic implementation is a mechanical device of spinning reels bearing symbols about their circumferences. A player wagers an amount and invokes the reels to spin. The reels stop at random positions with symbols on adjacent reels aligned along one or more pay lines. If predetermined symbols align on a pay line when the reels stop, then the player is awarded an amount that is proportional to the probability of the occurrence of the symbols. Video versions of game machines are now very popular and include not just simulations of spinning reel machines, but also representations of card games and other traditional wagering games.

One of the objectives of gaming regulation is to ensure that the playing of a gaming device is fair to all players regardless of any special physical or mental skills of the player. To that end, emphasis has been on the use of random selection techniques, such as using a random number generator, to provide a “level playing field” for each player. To a large extent this has been a very successful approach to gaming. With the advent of computer based gaming devices, a random game result can be effected by use of a software program that insures a consistently random result that is statistically sound. This approach has allowed for an independent verification of the device, which has assisted in achieving the goal of fairness by further limiting the opportunity to cheat the device.

One recent development in gaming is the addition of an element of mental skill in games such as video poker. In these games the player has similar choices as in the real card game. Such games can be implemented to insure that the minimum payout requirement of a jurisdiction can be achieved for an unskilled player while a skilled player can achieve a payout level that exceeds 100%. These types of games have proved to be very popular with players to the point that they are among the largest numbers of game types in American casinos.

There have been attempts to bring an element of mental skill into a slot machine type of game. One example is the Ripley's Believe It or Not® slot machine game manufactured by Mikohn Gaming Corporation. This game has a bonus feature which requires a player to select answers to questions. The player is provided a series of questions and four possible answers for each question. If he answers a question correctly on the first try, he is awarded a specified bonus amount. If he answers it incorrectly on the first try and correctly on the second try he is awarded a lower specified bonus amount. This continues until his forth try at which he is awarded the minimum specified bonus amount. He then proceeds to answer each question in a similar manner. At the end of the session his total credits are added up and if they exceed a certain minimum level he can proceed to the next level of questions.

In carnival-like games, physical skill is almost always the determining factor in who wins a prize. Such games as Ringing the Bell, Hoops and Target Shooting all require a high degree of physical skills such as eye-hand coordination, balance and strength. Such games are highly entertaining and enjoyable as evidenced by their popularity over the years and their widespread acceptance by a large segment of the population.

While the outcome of carnival-like games have always been the subject of informal wagers by individuals, such wagering or the use such carnival-like games has never been approved in by regulatory authorities. The primary reason is that the game cannot be made to be fair to all players if its primary attribute relies on the very distinctions in physical abilities that gaming regulation attempts to remove from a gaming device.

“Virtual Reality” is a term used for computer generated three dimensional environments that allow the user to enter and interact with alternate realities. The users are able to immerse themselves to varying degrees in a computer-generated artificial world, which can include a simulation of some form of reality. This is generally accomplished through the use of a Virtual Reality interaction system as known to those skilled in the art; such systems are designed to display the alternate reality to a user and allow interaction therewith. Such systems typically include a head mounted display and data glove and Virtual Reality stations that reproduce a specific area, such as a plane cockpit, the controls of a train engine, or the bridge of ship.

In simulation of reality, the focus is on reproducing perceptible aspects of a real environment as accurately as possible to create the illusion of an alternate reality. This can involve not only three dimensional images or holograms but also the incorporation of sounds, the generation of smells and technology that provides the sensation of touch. These computer generated realties may be representations of real world objects, or imaginary realties, created by a designer, etc. Typical examples of simulation of reality include architectural walkthroughs of buildings and Virtual Reality games.

Players involved in games of wagering often enjoy new games or variations of old games with relatively simple rules that can be readily learned by a beginner or casual player. Variations to a game with respect to the method of wagering and the ability to increase winnings attracts more players and is highly desired in the industry. The ability to increase winnings where risk is involved based on the selection of a possible random outcome is also highly desired. There has been an evolution of gaming devices over the past few decades. At the beginning of this evolution there were mechanical and electromechanical gaming devices, such as the traditional slot machine. The advent of relatively inexpensive computer processors and associated video display devices allowed the introduction of electronic gaming devices offering computer-emulated games and a pseudo display of the game action and outcome. The next evolution was the integration of communication capabilities between computers and gaming devices, allowing the interchange of data and information via a network between computers.

The development of communications between gaming machines and networks enabled the development of systems allowing the players at those machines to compete for additional prizes while playing the traditional wagering games. Among these are progressive gaming systems, such as those disclosed in U.S. Pat. No. 4,837,728 and U.S. Pat. No. 5,855,515, the disclosures of which are incorporated herein by reference. In a progressive system, a number of gaming machines are linked together to enable access to an available additional or bonus prize, the value of which increases as a portion of wagers are placed on the gaming machines is allocated to the bonus pool.

The networking of computers has also allowed and improved the ability to track the usage of individual gaming machines including the players using such a machine. Player tracking systems allow for the management of large numbers of gaming machines and players simultaneously. Examples of player tracking systems may be found in U.S. Pat. No. 6,165,071, U.S. Pat. No. 6,048,269, and U.S. Pat. No. 5,655,961, the disclosures of which are incorporated herein by reference. These systems allow players to carry credits from one gaming machine to another, thereby avoiding the use of coins or tokens, track the gaming usage of the players for marketing purposes, and allow the players to play for a higher payout upon meeting certain conditions.

It would be desirable to encourage players to continue their play on a gaming machine by providing an interactive bonus game that enables the use of a player's skills to increase the bonuses that may be earned by that player while still maintaining the level playing field required in a regulated environment. It would be further desirable for such a system to make carnival-like games available for use in a regulated gaming environment.

### BRIEF SUMMARY OF THE INVENTION

Various embodiments of the present invention comprise gaming machines and methods useful with a gaming system offering a shared Virtual Reality bonus event. One exemplary embodiment features a number of gaming machines linked to a bonus event computer. Each gaming machine is configured for play of a primary game in response to a wager. Primary game outcomes may be completely randomly determined, as in a reel-type slot machine game, or involve some element of player skill, such as video card games. Achieving one or more specific primary game outcomes provides a player with an opportunity to play a skill-based bonus game on that gaming machine, preferably a carnival-like game that awards a bonus related to the performance of a physical act. The skill based bonus game may be a Virtual Reality game. A bonus event computer networked to a plurality of gaming machines may be used to provide a shared Virtual Reality bonus event to qualified players, allowing the players to compete for additional bonus event prizes. Aspects of the shared Virtual Reality bonus event may be randomly assigned and the bonus event may be configured as a virtual auto race.

In exemplary embodiments of the present invention, the displayed indicia of the primary game offered on the gaming machines may be in the form of reels, indicia of reels, playing cards, indicia of playing cards, dice, indicia of dice, numbers, indicia of numbers, and combinations thereof.

### BRIEF DESCRIPTION OF THE SEVERAL VIEWS OF THE DRAWINGS

The nature of the present invention as well as other embodiments of the present invention may be more clearly understood by reference to the following detailed description, to the appended claims, and to the several drawings herein, wherein:

FIG. 1 is a schematic representation of one possible embodiment of a gaming machine that may be used in accordance with the principles of the present invention;

FIG. 2 is a representation of a bonus event gaming system that may be utilized in some possible embodiments of the present invention;

FIG. 3 is a multi-site ongoing bonus gaming system that may be utilized in some embodiments of the present invention;

FIG. 4 is a flowchart describing one exemplary embodiment of a process of including an interactive bonus game that includes an element of skill on a gaming machine, that may be used in one embodiment of the present invention; and

FIG. 5 is a flowchart describing one exemplary embodiment of a process including a shared Virtual Reality bonus event in connection with a number of gaming machines, in accordance with the principles of the present invention.

### DETAILED DESCRIPTION

The following describes several exemplary embodiments of the present invention. It will be appreciated that the examples used herein are illustrative only and not limiting of the invention.

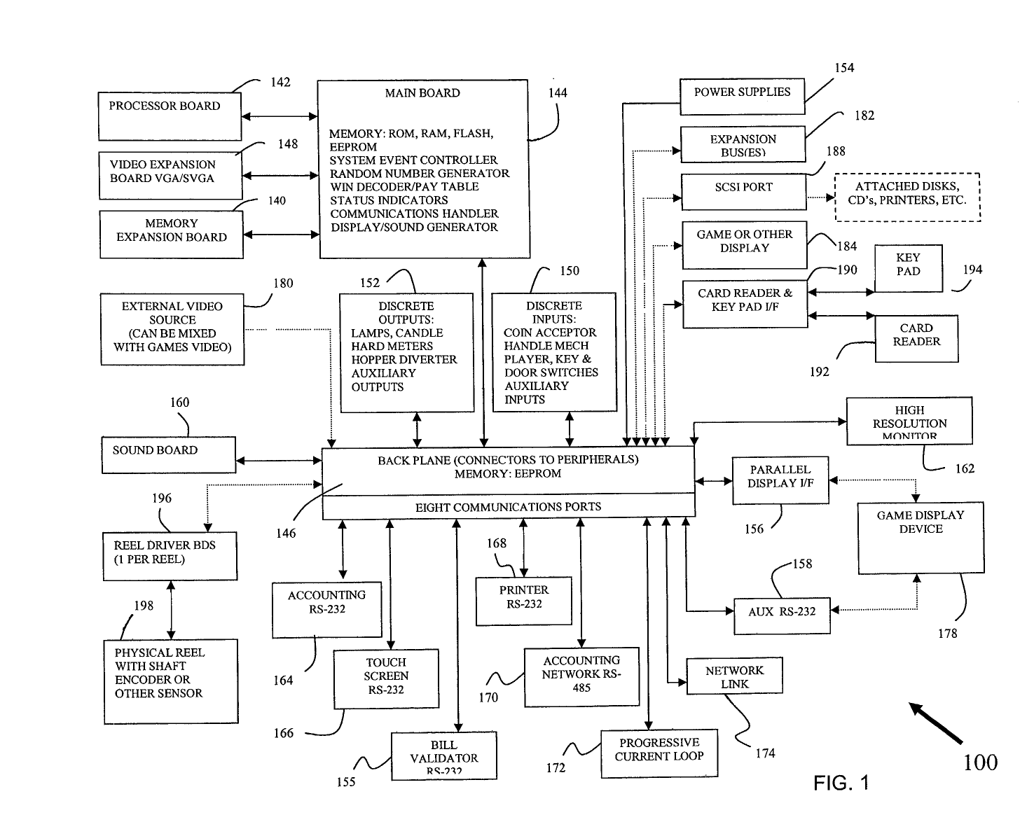

Referring to FIG. 1, gaming machine or device 100, which may also be termed a “gaming unit” herein, includes a memory board 140, a processor board 142, a main board 144 and a back plane 146 integrally or separately formed. Memory expansion board 140 as well as processor board 142 including a graphics system processor and video expansion board VGA/SVGA 148, are operably coupled to the main board 144. The main board 144 preferably includes memory in the form of ROM, RAM, flash memory and EEPROM (electrically erasable programmable read only memory). In addition, the main board 144 includes a system event controller, a random number generator, a win decoder/pay table, status indicators, a communications handler and a display/sound generator.

The main board 144 is operably coupled to the back plane 146, which may include additional memory, such as in the form of an EEPROM, and connectors to connect to peripherals. Furthermore, the back plane 146 provides a plurality of communication ports for communicating with external peripherals. The back plane 146 provides the coupling between discrete inputs 150 and the processor board 142 and main board 144. Typical examples of elements which provide discrete inputs 152 are coin acceptors, game buttons, mechanical hand levers, key and door switches and other auxiliary inputs. Furthermore, the back plane 146 provides the coupling between discrete outputs 152 and the processor and main board 144. Typically and by way of example only, elements that provide discrete outputs 152 are in the form of lamps, hard meters, hoppers, diverters and other auxiliary outputs.

The back plane 146 also provides connectors for at least one power supply 154 for supplying power for the processor and a parallel display interface (PDI) 156 and a serial interface 158 for game display device 178. In addition, the back plane 146 also provides connectors for a soundboard 160 and a high-resolution monitor 162. Furthermore, the back plane 146 includes communication ports for operably coupling and communicating with an accounting network 164, a touch screen 166 (which may also serve as a game display device), a bill validator 155 incorporated in a currency (bill) acceptor, a printer 168, an accounting network 170, a progressive current loop 172 and a network link 174.

The back plane 146 optionally includes connectors for external video sources 180, expansion buses 182, game or other displays 184, an SCSI port 188 and an interface 190 for at least one card reader 192 (debit/credit, player card, etc.) and key pad 194. The back plane 146 may also include means for coupling a plurality of reel driver boards 196 (one per reel) which drive physical game reels 198 with a shaft encoder or other sensor means to the processor board142 and main board 144 if a gaming device 100 is configured for play of a reel-type game. Of course, the reels may be similarly implemented electronically by display as video images, technology for such an approach being well known and widely employed in the art. In such an instance reel driver boards 196 and physical game reels 198 with associated hardware are eliminated and the game outcome generated by the random number generator on main board 144 is directly displayed on a video game display 184 and, optionally, on a separate game display device 178, as known in the art. Other gaming machine configurations for play of different wagering games such as video poker games, video blackjack games, video Keno, video bingo or any other suitable primary games are equally well known in the art. It will also be understood and appreciated by those of ordinary skill in the art that selected components of gaming device 100 may be duplicated for play of a bonus game or event in accordance with the present invention. In the conventional situation wherein the bonus game of the present invention may be operably coupled as a “top box” or otherwise associated with a conventional, existing gaming machine configured for play of a base game, many of the components illustrated in FIG. 1 and described with respect thereto will be duplicated, including separate software and associated memory for conducting play of the bonus game with associated pay tables for the bonus awards.

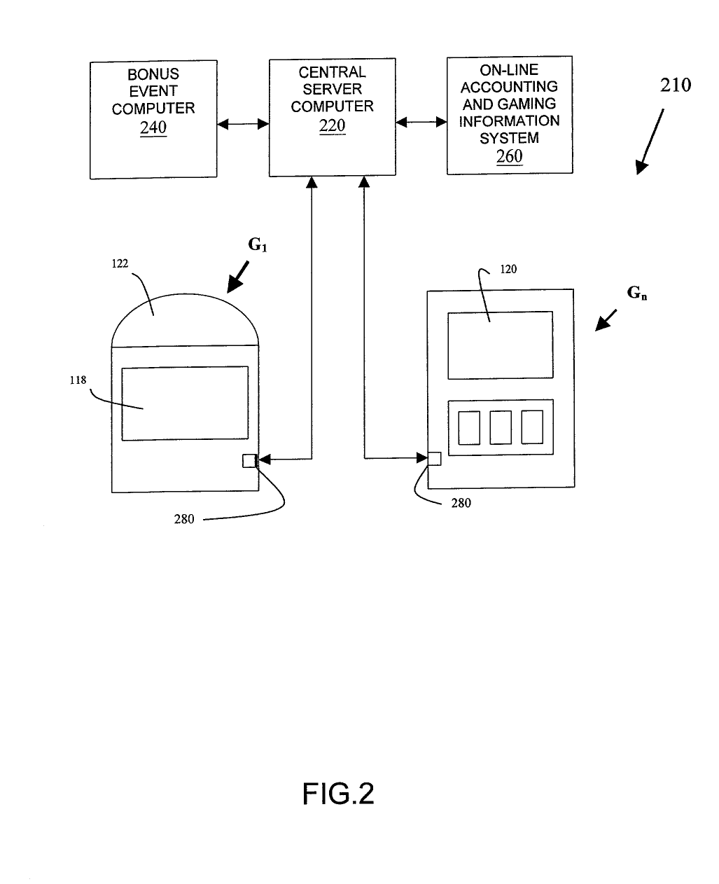

In implementation of the present invention, the gaming machines offering play of the bonus event of the present invention may be deployed, as schematically depicted in FIG. 2, in a gaming network 210 includes a central server computer 220 operably coupled to a plurality of gaming machine G₁, G₂ . . . Gₙ which may include both electronic and reel type game machines. It is notable that, unless the gaming network 210 is configured for progressive play, a variety of different makes of gaming machines G₁, G₂ . . . Gₙ offering widely different games may incorporated in gaming network 210, since the bonus event operates independently of the primary game on each gaming. The central server computer 220 automatically interacts with a plurality of gaming machines G₁, G₂ . . . Gₙ to activate a bonus event.

More specifically, and again referring to FIGS. 1 and 2, the gaming network 210 includes a central server computer 220, a bonus event computer 240 and a plurality of gaming machines G₁, G₂ . . . Gₙ. Each gaming machine G₁, G₂ . . . Gₙ includes a controller assembly 280 operably coupled to the central server computer 220 and is comprised of a controller unit designed to facilitate transmission of signals from each individual gaming machine G₁, G₂ . . . Gₙ to central server computer 220 for monitoring purposes. In addition, the controller assembly 280 includes a network interface board fitted with appropriate electronics for each specific make and model of each individual gaming machine G₁, G₂ . . . Gₙ.

Referring to FIG. 2, in electronic video games, the central server computer 220 is operably coupled to at least one video game display element 118 as shown at the left hand side of FIG. 2 and sequesters a portion of the video game display element 118 for displaying video attract sequences to attract potential players. Video game display element 118 may be used for display of both the primary and bonus games. Where the gaming network 210 includes reel type game machines G₁, G₂ . . . Gₙ, as shown at the right hand side of FIG. 2, the central server computer 220 may be operably coupled to at least one active display element 120 so that potential players receive a clear indication of attract sequences and the active display element 120 may be used as a video display for the bonus game. As shown at the left hand side of FIG. 2, the gaming machines G₁, G₂ . . . Gₙ may also be provided with a second video display element 122 as an alternative to sequestering a portion of the video game display element 118 for displaying video attract sequences and the bonus game. In addition, the central server computer 220 may include sound generating hardware and software for producing attractive sounds orchestrated with the video attract sequences at each of gaming machines G₁, G₂ . . . Gₙ if such is not already incorporated therein.

The games support input and output between the player and the game for such devices as heads up display, joystick, keyboard, mouse and data glove via interface modules connected through the expansion bus or buses 182 and SCSI port 188. A gaming machine G₁, G₂ . . . Gₙ thus may support a Virtual Reality interaction system, allowing a player thereat to be immersed in a computer generated reality. Such immersion may be accomplished by the use of a Virtual Reality “helmet” display, and associated inputs such as a data glove, by the use of a Virtual Reality chamber with associated inputs and displays to create the alternate reality sensations, or any other suitable devices known to those skilled in the art now or in the future. It will be appreciated that the term Virtual Reality chamber refers to a space, such as an enclosed area, that is connected to computer controlled displays and/or discrete outputs allowing the visual, audio and other sensory perception of a computer generated alternate reality to be projected to a user therein. Examples of Virtual Reality chambers include mock cockpits allowing a user the sensation of operating an airplane, or the group chambers found at amusement parks allowing a group to experience a Virtual Reality roller coaster event.

The attractive multimedia video displays and dynamic sounds may be provided by the central server computer 220 by using multimedia extensions to allow gaming machines G₁, G₂ . . . Gₙ to display full-motion video animation with sound to attract players to the machines. During idle periods, the gaming machines G₁, G₂ . . . Gₙ preferably display a sequence of attraction messages in sight and sound. The videos may also be used to market specific areas of the casino and may be customized to any informational needs.

Furthermore, the gaming network 210 includes bonus event computer 240 operably coupled to the central server computer 220 for scheduling bonus parameters such as the type of bonus game, pay tables and players. The functions of central server computer 220 and bonus event computer 240 may, of course, be combined in a single computer. Preferably, the gaming network 210 further includes a real-time or on-line accounting and gaming information system 260 operably coupled to the central server computer 220. The accounting and gaming information system 260 includes a player database for storing player profiles, a player tracking module for tracking players and a pit, cage and credit system for providing automated casino transactions.

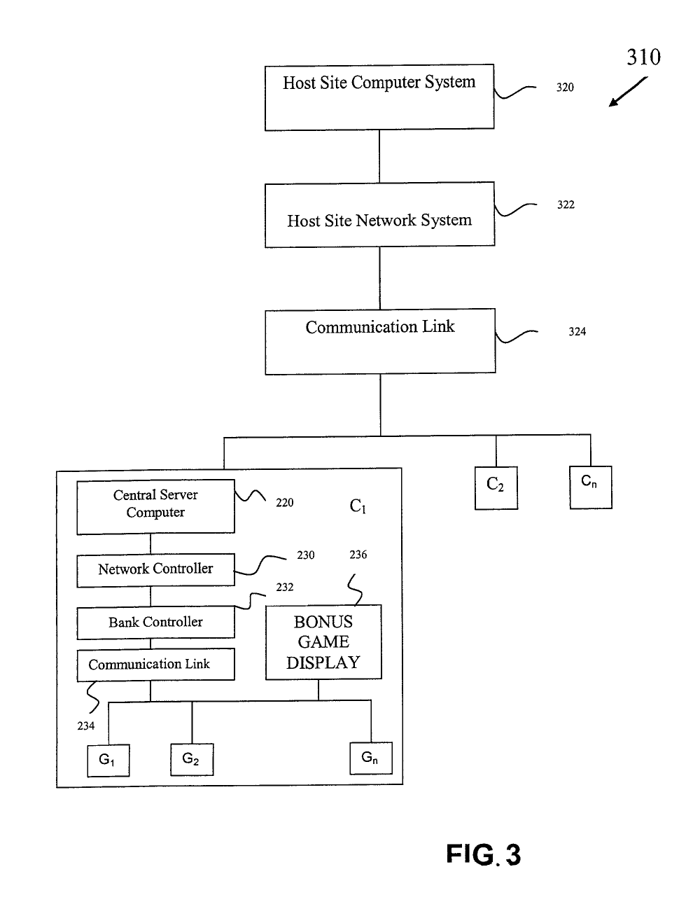

As previously implied, a bank of gaming machines G₁, G₂ . . . Gₙ may be networked together in a progressive configuration, as known in the art, wherein a portion of each wager to initiate a primary game may be allocated to bonus event wards. In addition, and referring to FIG. 3, a host site computer 320 is coupled to a plurality of the central servers 220 at a variety of mutually remote casinos or other gaming sites C₁, C₂ . . . Cₙ for providing a multi-site linked progressive automated bonus gaming system 310.

Preferably, the host site computer 320 will be maintained for the overall operation and control of the system 310. The host site computer 320 includes a computer network 322 and a communication link 324 provided with a high-speed, secure modem link for each individual casino site C₁, C₂ . . . Cₙ.

Each casino or other gaming site C₁, C₂ . . . Cₙ includes the central server computer 220 provided with a network controller 230 which includes a high-speed modem operably coupled thereto. Bidirectional communication between the host site computer 320 and each casino site central server 220 is accomplished by the set of modems transferring data over communication link 324.

A network controller 230, a bank controller 232 and a communication link 234 are interposed between each central server 220 and the plurality of networked gaming machines at each casino site C₁, C₂ . . . Cₙ. In addition, the network controller 230, the bank controller 232 and the communication link 234 may optionally be interposed between each central server 220 and at least one separate bonus game display 236 at each casino site C₁, C₂ . . . Cₙ. However, the system 310 may include hardware and software to loop back data for in-machine meter displays to communicate with bonus event award insert areas on gaming machines G₁, G₂ . . . Gₙ.

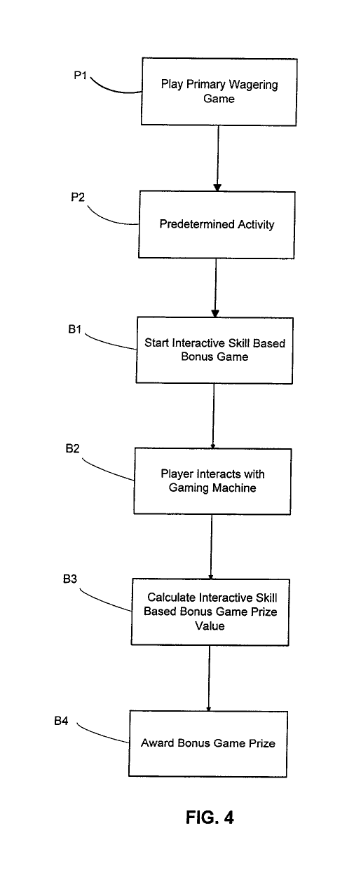

Turning to drawing FIG. 4, one exemplary embodiment of a process flow on a gaming machine including an interactive skill game, which is preferably an interactive physical skill game, is disclosed. For the purposes of clarity, this process flow will be discussed in connection with the exemplary implementations of the present invention illustrated in drawing FIGS. 1, 2 and 3. It will be appreciated that the following description is not limiting, but is illustrative only and that the process flow may be practiced with any suitable gaming system and that other suitable alternative process flows may be designed utilizing the teachings of the present invention, and all such variations are within the scope of the present invention.

The process begins with a player playing a primary or base game on a first gaming machine G₁, G₂ . . . Gₙ, as shown in box P1. The primary or base game may be any suitable game that may be played on an individual gaming unit, as described above. The primary game on each of gaming machines G₁, G₂ . . . Gₙ may be, for example, a multi-line, five-reel spinning reel game, either electromechanical with actual moving reels or electronic with simulated reels and movement thereof, the game awarding prizes when specified numbers, types and configurations of symbols, also termed “elements”, occur on a winning pay line or are otherwise visibly displayed in a winning pattern. Alternatively, the primary game may comprise any other reel-type game, card game, or other game of chance susceptible to representation in an electronic or electromechanical form. Typically, a player makes a wager on the gaming machine Gₙ, as by inserting a coin in a coin acceptor 152, a bill into a bill validator 155, a card into a card reader 192, or otherwise. The player then activates the primary or base game, resulting in the display of randomly determined indicia, as shown in drawing FIG. 4. It is preferred that the display of different combinations of indicia determine whether or not the player is awarded a prize in the base game and the amount of any prize awarded, according to an established pay table.

As shown in box P2, as a gaming machine G₁, G₂ . . . Gₙ is played, a predetermined activity that has been selected as a bonus game qualifying event will occasionally occur on that machine G₁, G₂ . . . Gₙ. While this predetermined activity may be any of a number of occurrences on the gaming machine Gₙ, it is preferred that it be a randomly occurring activity. For example, where the gaming machine Gₙ is a spinning reel machine, the random occurrence of a certain number of one or more symbols or elements at a line on a spin of the reels may be a bonus game qualifying event, as may be certain combinations of symbols or elements. With multiple pay line reel machines, these may be required to occur at a specific pay line or may be permitted at any pay line for a bonus game qualifying event. Alternatively, the placement of a wager of a certain amount on a gaming machine G₁, G₂ . . . Gₙ, the placement of a selected number or frequency of wagers, or the time spent playing a gaming machine G₁, G₂ . . . Gₙ may be the predetermined activity. For gaming machines G₁, G₂ . . . Gₙ offering other types of primary games, the predetermined activity may be any activity that can occur in association with game play on that machine, but it is preferred that the predetermined activity be an outcome of a base game. It will be appreciated that the predetermined activity may be any other event that may occur on a gaming machine G₁, G₂ . . . Gₙ. For example, and as noted previously with respect to a reel-type gaming machine, the placement of a wager of a certain value, the placement of a certain number or frequency of wagers by a player, or the passage of a set period of a time all may comprise a predetermined activity, although it may be preferred that the predetermined activity randomly occur. It will be appreciated that when a random outcome, the predetermined activity may be selected to occur at any desired percentage of the outcomes of a primary or base wagering game.

As shown in box B1, upon the occurrence of a predetermined activity, the bonus game, an interactive skill game begins. It will be appreciated that gaming machines G₁, G₂ . . . Gₙ adapted for some embodiments of this process flow may enable a player thereat to decline the opportunity to participate in a bonus game, either receiving a standard award (for example, an award less than might be obtained by playing the bonus game) or retaining the opportunity to participate in the bonus game at another point. The latter approach is easily implemented using conventional player tracking technology.

The bonus game begins, as depicted in box B1, and the player participates in the interactive skill game by interacting with the gaming machine G₁, G₂ . . . Gₙ or a component attached thereto, as shown in box B2. The interactive skill game may be an interactive physical skill game that requires a physical interaction with the player and awards a bonus game prize in proportion to a success level of that interaction. Examples of such suitable interactive physical skill games include carnival-like games, as would be found on a carnival midway. These interactive physical skill games may be implemented in physical embodiments using conventional hardware as known in the art for carnival-type games, enhanced technologically to accommodate space constraints present in a casino environment, or as Virtual Reality games.

One embodiment of a suitable interactive physical skill game is a hammer strike game. In such an embodiment, the gaming machine G₁, G₂ . . . Gₙ would include an associated bonus gaming unit comprising a striker, such as a hammer, and a strike receiver, such as a lever, plunger or a force sensor, as mechanical interaction components (discrete inputs 150). To participate in the bonus game, a player strikes the strike receiver with the striker. The value of the bonus prize awarded may be proportional to the force of the strike. The gaming machine Gₙ may include a discrete output 152 displaying the force of the strike, such as a weight that rises from base or resting level under the force of the strike, or a vertical series of lights that are activated, more lights being activated under application of greater force by the striker.

Another example of a suitable interactive physical skill game is an arm wrestling game. In such an embodiment, the gaming machine G₁, G₂ . . . Gₙ may include a bonus gaming unit comprising a pivotally-mounted mechanical arm as a discrete input 150. The mechanical arm may be permitted to pivot in only one direction, or about a number of degrees of freedom, and may be spring biased, pneumatically biased, hydraulically biased, magnetically biased, or otherwise, to provide a counterforce to the player. Upon activation of the bonus game, a player must manipulate the mechanical arm in an “arm wrestling match.” Aspects of the manipulation, such as the magnitude and direction of force applied by the player may be measured, for example by force sensors and accelerometers as known in the art, and used to calculate a proportionate or otherwise related bonus prize.

An additional example of a suitable interactive physical skill game is a shooting gallery type of game. In such an embodiment, the gaming machine G₁, G₂ . . . Gₙ may include an associated bonus gaming unit comprising a target display and a game gun. The bonus game commences with the display of targets on the target display and the player uses the game gun to “shoot” the targets. The game gun may use any suitable target shooting simulation technology known to those skilled in the art, such as a laser or light emitting diode. The targets may include light sensing elements and may be fixed, but are preferably moving to provide more of a challenge. The player may be enabled to choose different speeds of movement, single or multiple directions of movement, target shapes or sizes, etc., to play for various levels of bonus awards. A fixed number of shots may be made available to a player, or the targets may be displayed for a predetermined time period. A bonus award may be calculated based upon the number of targets hit, the number of targets hit per number of shots expended, or otherwise to establish the score within the bonus game. It is contemplated that this embodiment of the bonus game may be enabled with multiple levels, progressing from easier to more difficult, wherein a player must achieve a minimum score at each level to progress to a more difficult level with a greater associated bonus award.

One more example of an interactive physical skill game is a “skee ball” or “skeet ball” type of game. Upon the initiation of the bonus game, a player is provided with one or more balls. The player rolls a ball across a ball ramp having an end inclined toward a number of ball receivers, such as a number of target zones, which may comprise concentric rings. The zone or zones in which the ball or balls are received correlates to a score, or a bonus prize value.

As another approach to implementing interactive skill games according to the present invention and as noted previously, the interactive skill game may be provided using a Virtual Reality interaction system that is in communication with the gaming machine G₁, G₂ . . . Gₙ as the aforementioned “top box” or other associated bonus gaming unit, or a bonus game controller in the form of a separate bonus event computer networked to one or more, and preferably a plurality of, gaming machines G₁, G₂ . . . Gₙ. In such embodiments, the bonus game may require a player to access the Virtual Reality interaction system as enabled by occurrence of a predetermined activity associated with primary or base game play, or the primary or base game may also be provided using the Virtual Reality interaction system. Where the interactive skill game is an interactive physical skill game, provided using Virtual Reality, the components thereof may be computer generated and require the user to participate using a Virtual Reality interaction system including discrete inputs 152, such as a data glove. Examples include a hammer strike game where a player strikes a computer generated strike receiver with a computer generated striker, an arm wrestling game where a player “wrestles” a computer generated opponent, a target shooting game where a player uses a computer generated gun to shoot computer generated targets, and a skee ball or skeet ball game where player attempts to hit computer generated targets with a computer generated ball.

Alternative interactive skill games provided through Virtual Reality may include games where the outcome is based at least in part on a nonphysical skill of a player, such as knowledge of a subject or intuition. An example of such a game is a prediction game, where a player attempts to predict the outcome of a computer generated random event in order to receive a bonus prize. In a second embodiment, the player may compete against a computer generated predictor, such as a computer generated tarot card reader, in predicting randomly generated events to be awarded a bonus prize in proportion to the competitive success rate.

It will be appreciated that other embodiments of interactive physical skill games and Virtual Reality interactive skill games may be designed and utilized with gaming machines, and that all such embodiments are within the scope of the present invention. One preferred method of offering interactive skill bonus games, or interactive skill based wagering games, is to provide a plurality of gaming machines G₁, G₂ . . . Gₙ offering a number of different interactive skill games arranged as if in a carnival midway, or traditional boardwalk.

At the conclusion of the player interaction, the value of the bonus game prize is calculated, as shown in box B3. Preferably, the bonus game prize award is structured proportionate to a component of the interaction with the interactive skill game. The bonus game prize is then awarded as shown in box B4. Using an embodiment of the process as discussed above, a carnival-like game may incorporated into a gaming machine, or system for use in a regulated jurisdiction. The primary wagering game may be used to meet the minimum payout requirements under the regulations (the “level playing field”) and the interactive bonus game may provide a chance to increase payouts in response to a player's skills in different games. Alternatively, a gaming machine, or process may be configured to offer a multi-tiered interactive skill game, such as a carnival-like game as a primary or base game, using a random number generator to randomly determine an initial outcome of the interactive skill game, which may meet the jurisdictional minimum payout requirements, and then allow a player's skilled interaction to potentially increase the prize awarded. All such embodiments are within the scope of the present invention.

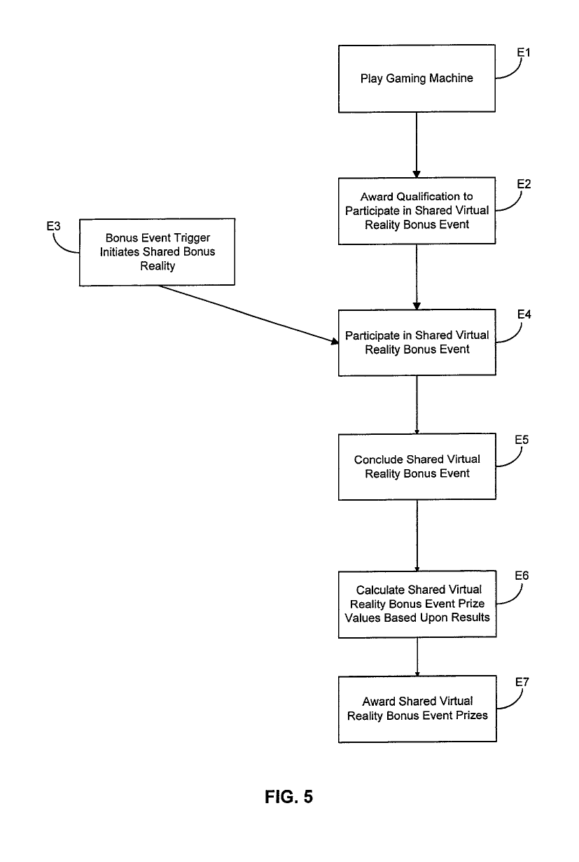

Turning to drawing FIG. 5, a flow chart is shown illustrating one embodiment of a process flow including a shared Virtual Reality bonus event. As with the process flow depicted in drawing FIG. 4, it will be appreciated that the process flow shown is illustrative only and is not intended to limit or restrict the present invention, which is defined by the appended claims.

As shown in box E1, play begins on a first gaming machine G₁, G₂ . . . Gₙ or other gaming unit of a networked gaming system similar to that depicted in drawing FIGS. 2 and 3. Upon the occurrence of a predetermined activity, a qualification to participate in a shared Virtual Reality bonus event is awarded, as shown in box E2. This may occur in any suitable fashion, similar to that discussed above in connection with drawing FIG. 4. In embodiments where the gaming machines Gₙ feature a bonus game, it is preferred that the shared bonus event participation be awarded as one possible outcome of the bonus game. The bonus game may be an interactive skill game, using a process similar to that discussed above.

The qualification to participate in a shared bonus event may be awarded in a number of different ways. For example, it may be awarded to the gaming machine G₁, G₂ . . . Gₙ, allowing any player thereat to participate in the shared Virtual Reality bonus event upon its occurrence. Alternatively, one preferred embodiment of a system for offering a shared Virtual Reality bonus event features a number gaming machines G₁, G₂ . . . Gₙ, networked together and to a bonus event computer 240. At a shared bonus event location, preferably nearby, one or more Virtual Reality interaction systems are available to be utilized by players in the shared Virtual Reality bonus event. In such an embodiment, a qualification may be awarded to a player at a gaming machine Gₙ in the form of a token or a ticket that may be redeemed at the shared bonus event location allowing for participation in a shared Virtual Reality bonus event. The player may be able to redeem the token or ticket for participation in a specific shared Virtual Reality bonus event, or any set selection of such events.

In an alternative embodiment, a gaming network 210 useful for practicing a process similar to that of drawing FIG. 5. includes a player tracking system, as known to those of ordinary skill in the art, administered by an on-line gaming and accounting information system 260 (FIG. 2). By using player cards that are inserted into a card reader 192, unique codes that are input into a keypad 194, or through any other similar process known in the art, players can be uniquely identified. When a uniquely identified player at a gaming unit G₁, G₂ . . . Gₙ, is awarded a qualification for participation is associated with that player. The qualification may be retained in a bonus event controller or a memory of the gaming machine G₁, G₂ . . . Gₙ, or it may be retained elsewhere, as in the player tracking system or on a player identification card and accessed by the bonus event controller at the time of a shared Virtual Reality event.

The ability to associate a qualification, or entry with a specific player adds another level of flexibility to gaming systems in accordance with the present invention. The system may be configured to let a uniquely identified player stopping play prior to a shared Virtual Reality bonus event to retain their entries and utilize them the next time they play. A uniquely identified player may also be able to stop play on a first gaming machine G₁ and move to another gaming machine G₂ and continue play while retaining the entries obtained at the first machine G₁. In embodiments that include a multi-site system, such as that depicted in drawing FIG. 3, a uniquely identified player may even be able to utilize entries obtained at a first casino C₁ during play at a second casino C₂ in the gaining system 310. This allows the system to be used to encourage players to return to one of a group of related casinos.

Upon the occurrence of a bonus event trigger, a bonus controller, such as bonus event computer 240, initiates a shared Virtual Reality bonus event, as shown in box E3. A player holding a qualification to participate therein then participates in that shared Virtual Reality bonus event, as shown in box E4. This can be accomplished by one of the methods discussed, or in a number of other methods, within the scope of the present invention. For example, where a gaming machine G₁, G₂ . . . Gₙ includes a Virtual Reality interaction system in communication therewith, the bonus controller may utilize a linked plurality of such machines to provide the shred Virtual Reality bonus event. Alternatively, the system may provide directions to a layer at each qualifying machine to proceed to a specific station, or Virtual Reality interaction system at a bonus event location. Alternative methods are readily available to those skilled in the art and all such methods are included within the present invention.

The bonus event trigger may be any event that can be used to initiate the shared Virtual Reality bonus event. Examples of such events include preselected times that are made known to players, the random occurrence of a preselected outcome on any gaming machine G₁, G₂ . . . Gₙ networked to the gaming system 210, the passage of a fixed interval of time, the playing of a fixed number of games on the gaining machines G₁, G₂ . . . Gₙ attached to the gaming system 210, the placement of a certain wager on any gaming machine Gₙ, the awarding of a certain number of qualifications to participate in the shared Virtual Reality bonus event by the gaming system 210, or any other occurrence that may be used to trigger a bonus event.

The shared bonus reality event may be a competitive event in which participating players compete against one another for bonus event prizes. An example of a shared Virtual Reality bonus event that may be used in accordance with the principles of the present invention is a race car game, whereby a number of players participate in a Virtual Reality automobile race. The shared bonus event location, and the gaming system 210 may be decorated in a race theme, including a number of Virtual Reality interaction systems that have the appearance of futuristic race cars. When a player is enclosed in a Virtual Reality interaction system, the sensations of operating a race car in a race will be created and conveyed to the player. It will, of course, be appreciated that the race car game is only one example of a shared Virtual Reality bonus event, and that any shared Virtual Reality bonus event may be used and is within the scope of the present invention.

The bonus computer 240 assigns a number of elements to the players that affect their ability to perform in the shared Virtual Reality bonus event. Preferably, this assignment is accomplished randomly, using a random selection process as known in the art. It is preferred that some elements be randomly assigned to each player in the shared bonus event. Example of such elements in the exemplary race car game include the model of car, the amount of fuel in the car, the type of tires on the car or any other element in the game that may be individually assigned. The game may allow a player to alter or upgrade the individually assigned elements in exchange for one or more credits, such as allowing a player to purchase additional fuel by inserting money or another creditor credits, or allowing the player to obtain tires for driving in wet conditions in exchange for a second qualification to participate a shared Virtual Reality bonus event. It is further preferred that one or more elements be assigned in common to all of the players participating in the shared Virtual Reality bonus event. Examples of common elements to be used in the exemplary race car game include a selection of a type of car (Formula 1, NASCAR, etc.) a race course configuration from (for example) a number of famous race courses and the weather conditions during the race.

The players then participate in the shared Virtual Reality bonus event, as shown in box E4, preferably competing against one another until the game concludes, as shown in box E5. At the conclusion of the game, the results of the competition are reported to each of the players. Bonus event prize values are then calculated for each player, as shown in box E6, and the bonus prizes are awarded, as shown in box E7. If a large number of players participate in the shared Virtual Reality bonus event, it may be conducted in plurality of tiers or “heats” (in the case of a car race), where the top finishers proceed to the next tier for an enhanced bonus award.

It will be appreciated that modifications to the above examples or alternative interactive physical skill bonus games and shared Virtual Reality bonus events may be created by those of ordinary skill in the art. All such modifications and alternative games and the systems and methods of using fall within the scope of the present invention. It will be further appreciated that any method, system or device providing such games in connection with a gaming machine may fall within the scope of the present invention.

Accordingly, the present invention includes a method of providing an interactive physical skill game on a gaming machine, comprising a number of acts. A first gaming unit is provided, that is configured to operate a primary wagering game. The outcome of the primary wagering game may be randomly selected. A bonus game controller is attached in operative communication with the first gaming unit. The bonus game controller being configured to initiate a bonus game upon the occurrence of a predetermined activity associated with the first gaming unit. The bonus game is an interactive physical skill game awarding a bonus in proportion to a level of a corresponding physical interaction of a player with the first gaming unit. The interactive physical skill game is initiated in response to that predetermined activity; and a bonus is awarded to the player in proportion to the corresponding physical interaction.

The bonus game controller and the first gaming unit may be integrated in a single gaming machine. The gaming machine may further comprise mechanical interaction components as discussed above; such as a striker and strike receives for a hammer strike game, a mechanical arm for an arm wrestling game, a target display and a game gun for a shooting game, or a ball ramp and a number of ball receivers for a ball rolling game. The bonus prize awarded will preferably be proportional to an aspect of the physical interaction. Alternatively the bonus game controller may be in operative communication with a Virtual Reality interaction system and provide the bonus game as an interactive computer generated Virtual Reality game over that system. The interactive computer generated Virtual Reality game may be any suitable game, such as a hammer strike game, an arm wrestling game, a target shooting game, or a ball game, where the interaction components are computer generated.

The qualifying predetermined activity may be any suitable activity such as a specific predetermined random outcome occurring in the primary wagering game in response to a wager placed by a player, a wager of a predetermined value, or a predetermined number of wagers, or any other suitable activity as discussed herein.

The present invention further includes a method of playing a game of chance, comprising the acts of placing a wager with a gaming machine configured to generate a series of random outcomes in a primary wagering game; qualifying for participation in a shared Virtual Reality bonus event upon the occurrence of a predetermined activity on the gaming machine; and participating in a shared Virtual Reality bonus event to receive a bonus event award based on that participation.

The predetermined activity may be any event occurring on the gaming machine, including a predetermined random outcome occurring in the primary wagering game. Alternatively, the gaming machine may include a bonus game controller that initiates a bonus game upon the occurrence of a predetermined random outcome. The predetermined activity may occur by participating in that bonus game and earning a bonus event. The bonus game may be an interactive skill game requiring an interaction with the gaming machine, such as a hammer strike game, a arm wrestling game, a shooting game a ball rolling game or a prediction game, as discussed herein or another suitable game. The gaming machine may include any mechanical components necessary for operating that bonus game, as discussed herein. Where the gaming machine is in operative communication with a Virtual Reality interaction system, the bonus game may be an interactive computer generated Virtual Reality game as discussed herein. It is preferred that such a Virtual Reality game be an interactive skill game, such as a hammer strike game, arm wrestling game, shooting game, ball rolling game or prediction game as discussed herein, or other suitable game using computer generated components.

The shared Virtual Reality bonus event may be any suitable event as discussed herein, including a racing game like the car race game discussed above. It is preferred that the shared Virtual Reality bonus event requires a player to compete against other players to receive a bonus event award. It is further preferred that the shared Virtual Reality bonus event includes one or more common game elements randomly assigned in common to all players and one or more individual game elements randomly assigned individually to each player. It is further preferred that the players be able to alter the individually assigned game elements in exchange for credits.

Although the present invention has been shown and described with respect to preferred embodiments, various additions, deletions and modifications that are obvious to a person skilled in the art, even if not shown or specifically described herein, are deemed to lie within the scope of the invention as encompassed by the following claims.

What is claimed is:

1. A gaming device comprising:
a first gaming unit configured for operating a primary game thereon, an outcome of said primary game being randomly selected; and
a bonus game controller connected to said first gaming unit, said bonus game controller configured for initiating a bonus game upon the occurrence of a predetermined activity associated with said first gaming unit, said bonus game including comprising an interactive game of skill awarding a bonus in relation to a level of a corresponding physical interaction of a player with said first gaming unit.

2. The gaming device of claim 1, further comprising a strike receiver and a striker.

3. The gaming device of claim 2, wherein said interactive physical game of skill comprises a player striking said strike receiver with said striker, to receive a bonus award.

4. The gaming device of claim 1, further comprising a mechanical arm.

5. The gaming device of claim 4, wherein said interactive physical game of skill comprises an arm wrestling game, requiring a player to manipulate said mechanical arm to receive a bonus award.

6. The gaming device of claim 1, further comprising a target display and a game gun.

7. The gaming device of claim 6, wherein said interactive physical game of skill comprises a shooting game having a player shooting images displayed on said target display for receiving a bonus award.

8. The gaming device of claim 1, further comprising a ball ramp and a number of ball receivers.

9. The gaming device of claim 8, wherein said interactive physical game of skill comprises a ball rolling game requiring a player to roll a ball across said ball ramp into one of said ball receivers to receive a bonus award associated with said one of said ball receivers.

10. The gaming device of claim 1, further comprising at least one Virtual Reality interaction system connected to said bonus game controller.

11. The gaming device of claim 10, wherein said interactive physical game of skill comprises an interactive computer generated Virtual Reality game accessible to a player using said at least one Virtual Reality interaction system.

12. The gaming device of claim 11, wherein said interactive computer generated Virtual Reality game comprises a hammer strike game having said player striking a computer generated strike receiver using a computer generated striker.

13. The gaming device of claim 11, wherein said interactive computer generated Virtual Reality game comprises an arm wrestling game having said player arm wrestle a computer generated opponent for receiving a bonus award.

14. The gaming device of claim 11, wherein said interactive computer generated Virtual Reality game comprises a computer generated shooting game having said player shooting computer generated images for receiving a bonus award.

15. The gaming device of claim 11, wherein said interactive computer generated Virtual Reality game comprises a computer generated ball game requiring said player to hit computer generated targets with a computer generated ball for receiving a bonus award.

16. The gaming device of claim 1, wherein said predetermined activity comprises a specific predetermined random outcome occurring in said primary wagering game in response to a wager placed on said first gaming unit.

17. The gaming device of claim 1, wherein said predetermined activity comprises a wager of a predetermined value being placed on said first gaming unit.

18. The gaming device of claim 1, wherein said predetermined activity comprises a predetermined number of wagers being placed on said first gaming unit.

19. A gaming device comprising:
a gaming unit configured for operating a primary game thereon, an outcome of said primary game being randomly selected;
a bonus game controller connected to said gaming unit, said bonus game controller configured for conducting an interactive bonus game upon the occurrence of a predetermined activity associated with said first gaming unit, said bonus game comprising an interactive computer generated Virtual Reality game; and
at least one Virtual Reality interaction system for communicating with said bonus game controller.

20. The gaming device of claim 19, wherein said interactive computer generated Virtual Reality game is accessible to a player using said at least one Virtual Reality interaction system.

21. The gaming device of claim 20, wherein said interactive computer generated Virtual Reality game comprises a hammer strike game having said player striking a computer generated strike receiver using a computer generated striker.

22. The gaming device of claim 20, wherein said interactive computer generated Virtual Reality game comprises an arm wrestling game having said player arm wrestle a computer generated opponent for receiving a bonus award.

23. The gaming device of claim 20, wherein said interactive computer generated Virtual Reality game comprises a computer generated shooting game having said player shooting computer generated images for receiving a bonus award.

24. The gaming device of claim 20, wherein said interactive computer generated Virtual Reality game comprises a computer generated ball game having said player hitting computer generated targets using a computer generated ball for receiving a bonus award.

25. The gaming device of claim 20, wherein said interactive computer generated Virtual Reality game comprises a prediction game having said player competing in making successful predictions against a computer generated predictor for receiving a bonus award.

26. The gaming device of claim 20, wherein said interactive computer generated Virtual Reality game comprises a racing game having said player participating in a race for receiving a bonus award.

27. The gaming device of claim 19, wherein said predetermined activity comprises a specific predetermined random outcome occurring in said primary wagering game in response to a wager placed on said first gaming unit.

28. The gaming device of claim 19, wherein said predetermined activity comprises a wager of a predetermined value being placed on said first gaming unit.

29. The gaming device of claim 19, wherein said predetermined activity comprises a predetermined number of wagers being placed on said first gaming unit.

30. A gaming system, comprising:
a bonus event controller configured for operating a shared Virtual Reality bonus event in response to a bonus event trigger; and
a plurality of gaming units for communication with said bonus event controller, each gaming unit configured for operating a primary wagering game thereon and for providing qualifications for participating in said shared Virtual Reality bonus event for a player located thereat.

31. The gaming system of claim 30, wherein each gaming unit comprises a microprocessor for producing a plurality of random outcomes.

32. The gaming system of claim 31, wherein said microprocessor utilizes a random number generator.

33. The gaming system of claim 30, where each gaming unit is configured for providing said qualification for participating in said shared Virtual Reality bonus event in response to a predetermined activity occurring thereat.

34. The gaming system of claim 33, wherein said predetermined activity comprises a specific predetermined random outcome occurring in said primary game in response to a wager placed on a said gaming unit of said plurality.

35. The gaming system of claim 33, wherein each of said gaming units further comprises a bonus game controller for initiating a bonus game upon an occurrence of a predetermined outcome of said primary game.

36. The gaming system of claim 35, wherein said predetermined activity comprises a specific bonus game outcome occurring in said bonus game.

37. The gaming system of claim 36, wherein said bonus game comprises an interactive skill game awarding a bonus in response to an interaction of a player with a said gaming unit.

38. The gaming system of claim 37, wherein a said gaming unit comprises a strike receiver and a striker.

39. The gaming system of claim 38, wherein said interactive skill game comprises a player striking said strike receiver with said striker.

40. The gaming system of claim 37, wherein a said gaming unit comprises a mechanical arm.

41. The gaming system of claim 40, wherein said interactive skill game comprises an arm wrestling game having a player manipulate said mechanical arm.

42. The gaming system of claim 37, wherein a said gaming unit comprises a target display and a game gun.

43. The gaming system of claim 42, wherein said interactive skill game comprises a shooting game having a player shoot images displayed on said target display using said game gun.

44. The gaming system of claim 37, wherein a said gaming unit comprises a ball ramp and a number of ball receivers.

45. The gaming system of claim 44, wherein said interactive skill game comprises a ball rolling game having a player roll a ball across said ball ramp into one of said ball receivers.

46. The gaming system of claim 37, wherein said interactive skill game comprises a prediction game having a player predict an event occurring within said interactive skill game.

47. The gaming system of claim 37, wherein said gaming unit comprises at least one Virtual Reality interaction system operably coupled thereto.

48. The gaming system of claim 47, wherein said interactive skill game comprises an interactive computer generated Virtual Reality game accessible to a player using said at least one Virtual Reality interaction system.

49. The gaming system of claim 48, wherein said interactive computer generated Virtual Reality game comprises a hammer strike game requiring said player to strike a computer generated strike receiver using a computer generated striker.

50. The gaming system of claim 48, wherein said interactive computer generated Virtual Reality game comprises an arm wrestling game requiring said player to arm wrestle a computer generated opponent.

51. The gaming system of claim 48, wherein said interactive computer generated Virtual Reality game comprises a computer generated shooting game requiring said player to shoot computer generated images.

52. The gaming system of claim 48, wherein said interactive computer generated Virtual Reality game comprises a computer generated ball game requiring said player to hit computer generated targets with a computer generated ball.

53. The gaming system of claim 48, wherein said interactive computer generated Virtual Reality game comprises a prediction game requiring said player to compete in making successful predictions against a computer generated predictor.

54. The gaming system of claim 30, wherein said plurality of gaming units comprises at least one gaming unit located at each of at least two mutually remotely located casinos.

55. The gaming system of claim 30, wherein each of said gaming units includes a device for uniquely identifying a player making a wager at said first gaming unit.

56. The gaming system of claim 30, wherein said shared Virtual Reality bonus event comprises a racing game.

57. The gaming system of claim 30, wherein said shared Virtual Reality bonus event is configured to enable a number of players to compete against one another to receive bonus awards based upon performance.

58. The gaming system of claim 57, wherein said bonus event controller randomly assigns at least one common game element common to all of said players in said shared Virtual Reality bonus event.

59. The gaming system of claim 57, wherein said bonus event controller randomly assigns at least one individual game element individually to each of said players in said shared Virtual Reality bonus event.

60. The gaming system of claim 59, wherein each of said players is enabled to alter said at least one individual game element in exchange for tendering one or more credits.

61. The gaming system of claim 30, wherein said bonus event controller comprises a bonus event computer.

62. The gaming system of claim 30, wherein said shared Virtual Reality bonus event is conducted using a plurality of Virtual Reality interaction systems.

63. The gaming system of claim 62, wherein each Virtual Reality interaction system of said plurality of Virtual Reality interaction systems is operably coupled to one of said first gaming units.

64. The gaming system of claim 62, wherein said plurality of Virtual Reality interaction systems is located at a shared bonus event location that is separate from said plurality of first gaming units.

65. The gaming system of claim 30, wherein said bonus event trigger comprises a specific predetermined random outcome occurring in response to a wager placed on any of said gaming units.

66. The gaming system of claim 30, wherein said bonus event trigger comprises a predetermined number or frequency of wagers being placed on said plurality of first gaming units.

67. The gaming system of claim 30, wherein said bonus event trigger comprises a passing of a fixed amount of time.

68. The gaming system of claim 30, wherein a player at one of said plurality of first gaming units may decline an opportunity to participate in a shared bonus event.

69. The gaming system of claim 30, wherein a player obtaining an additional qualification to participate in said shared bonus event is qualified to participate in a second occurrence of shared bonus event.

70. The gaming system of claim 32, wherein a player may retain said qualification to participate in a shared bonus event upon ceasing a session of play and participate in a later occurrence of a shared bonus event upon returning and initiating a subsequent session of play.

71. A method of providing an interactive physical skill game on a gaming machine, comprising:
providing a gaming unit for operating a primary game thereon, an outcome of said primary game being randomly selected;
operably coupling a bonus game controller connected to said gaming unit, said bonus game controller for initiating a bonus game upon the occurrence of a predetermined activity associated with said gaming unit, said bonus game comprising an interactive physical skill game awarding a bonus in proportion to a level of a corresponding physical interaction of a player with said gaming unit;
initiating said interactive physical skill game in response to said predetermined activity; and
awarding a bonus to said player in proportion to said corresponding physical interaction.

72. The method of claim 71, further comprising configuring said bonus game controller in communication with said first gaming unit that said bonus game controller and said first gaming unit are integrated in a gaming machine.

73. The method of claim 72, wherein said gaming machine comprises a strike receiver and a striker.

74. The method of claim 73, wherein said interactive physical skill game comprises a player striking said strike receiver with said striker, to receive a bonus award in proportion to the force of said striking.

75. The method of claim 72, wherein said gaming machine comprises a mechanical arm.

76. The method of claim 75, wherein said interactive physical skill game comprises an arm wrestling game having a player manipulate said mechanical arm to receive a bonus award in proportion to the force of said manipulation.

77. The method of claim 72, wherein said gaming machine comprises a target display and a game gun.

78. The method of claim 77, wherein said interactive physical skill game comprises a shooting game having a player to shoot images displayed on said target display with said game gun to receive a bonus award proportional to a number of images shot by said player.

79. The method of claim 72, wherein said gaming machine further comprises a ball ramp and a number of ball receivers.

80. The method of claim 79, wherein said interactive physical skill game comprises a ball rolling game having a player to roll a ball across said ball ramp into one of said ball receivers for receiving a bonus award associated with said one of said ball receivers.

81. The method of claim 71, further comprising at least one Virtual Reality interaction system operably coupled to said bonus game controller.

82. The method of claim 81, wherein said interactive physical skill game comprises an interactive computer generated Virtual Reality game accessible to a player using said at least one Virtual Reality interaction system.

83. The method of claim 82, wherein said interactive computer generated Virtual Reality game comprises a hammer strike game requiring said player to strike a computer generated strike receiver with a computer generated striker to receive a bonus award proportional to a force of said strike.

84. The method of claim 82, wherein said interactive computer generated Virtual Reality game comprises an arm wrestling game requiring said player to arm wrestle a computer generated opponent to receive a bonus award in proportion to a force of said arm wrestling.

85. The method of claim 82, wherein said interactive computer generated Virtual Reality game comprises a computer generated shooting game having said player shoot computer generated images for receiving a bonus award in proportion to a number of said images shot by said player.

86. The method of claim 82, wherein said interactive computer generated Virtual Reality game comprises a computer generated ball game having said player hitting computer generated targets using a computer generated ball for receiving a bonus award in proportion to said computer generated targets hit.

87. The method of claim 71, wherein said predetermined activity comprises a specific predetermined random outcome occurring in said primary wagering game in response to a wager placed on said first gaming unit by said player.

88. The method of claim 71, wherein said predetermined activity comprises a wager of a predetermined value being placed on said first gaming unit by said player.

89. The method of claim 71, wherein said predetermined activity comprises a predetermined number of wagers being placed on said first gaming unit by said player.

90. A method of playing a game of chance, comprising:
placing a wager with a gaming machine for generating a series of random outcomes in a primary game; and
qualifying for participating in a shared Virtual Reality bonus event upon an occurrence of a predetermined activity on said gaming machine; and
participating in a shared Virtual Reality bonus event for receiving a bonus event award when qualified to participate in said shared Virtual Reality bonus event.

91. The method of claim 90, wherein said predetermined activity comprises a predetermined random outcome occurring in said primary game in response to said wager placed on said gaming machine.

92. The method of claim 90, wherein said gaming machine further comprises a bonus game controller configured for initiating a bonus game upon an occurrence of a predetermined random outcome of said primary game.

93. The method of claim 92, wherein said predetermined activity comprises participating in said bonus game and earning a bonus event award in said bonus game.

94. The method of claim 93, wherein said bonus game comprises an interactive skill game having an interaction with said gaming machine.

95. The method of claim 94, wherein said gaming machine comprises a strike receiver and a striker.

96. The method of claim 95, wherein said interactive skill game comprises striking said strike receiver with said striker.

97. The method of claim 94, wherein said gaming machine comprises a mechanical arm.

98. The method of claim 97, wherein said interactive skill game comprises manipulating said mechanical arm.

99. The method of claim 94, wherein said gaming machine comprises a target display and a game gun.

100. The method of claim 99, wherein said interactive skill game comprises shooting images displayed on said target display with said game gun.

101. The method of claim 94, wherein said gaming machine comprises a ball ramp and a number of ball receivers.

102. The method of claim 101, wherein said interactive skill game comprises rolling a ball across said ball ramp into one of said ball receivers.

103. The method of claim 94, wherein said interactive skill game comprises predicting an outcome of an event generated in said interactive skill game.

104. The method of claim 94, wherein said gaming machine comprises at least one Virtual Reality interaction system connected thereto.

105. The method of claim 104, wherein said interactive skill game comprises an interactive computer generated Virtual Reality game accessible using said at least one Virtual Reality interaction system.

106. The method of claim 105, wherein said interactive computer generated Virtual Reality game comprises striking a computer generated strike receiver with a computer generated striker.

107. The method of claim 105, wherein said interactive computer generated Virtual Reality game comprises arm wrestling computer generated opponent.

108. The method of claim 105, wherein said interactive computer generated Virtual Reality game comprises shooting computer generated images using a computer generated gun.

109. The method of claim 105, wherein said interactive computer generated Virtual Reality game comprises hitting computer generated targets by throwing a computer generated ball.

110. The method of claim 105, wherein said interactive computer generated Virtual Reality game comprises competing in making successful predictions against a computer generated predictor.

111. The method of claim 90, wherein said shared Virtual Reality bonus event comprises a racing game.

112. The method of claim 90, wherein said shared Virtual Reality bonus event requires competing against other players to receive a bonus event award.

113. The method of claim 112, wherein said shared Virtual Reality bonus event comprises at least one common game element randomly assigned in common to all players in said shared Virtual Reality bonus event.

114. The method of claim 112, wherein said shared Virtual Reality bonus event comprises at least one individual game element randomly assigned individually to each of said players in said shared Virtual Reality bonus event.

115. The method of claim 114, further comprising altering said at least one individual game element in exchange for one or more credits.
